(19) United States
(12) Patent Application Publication
(10) Pub. No.: US 2025/0006066 A1
(43) Pub. Date: Jan. 2, 2025

(54) METHOD AND APPARATUS FOR CREATING AND MANAGING DIGITAL TRAFFIC LIGHTS IN THE AIRSPACE

(71) Applicant: UNIVERSITY OF NORTH TEXAS, Dallas, TX (US)

(72) Inventors: Kamesh NAMUDURI, Dallas, TX (US); Logan MCCORKENDALE, Dallas, TX (US); Zachary MCCORKENDALE, Dallas, TX (US); Mathias KIDANE, Dallas, TX (US)

(21) Appl. No.: 18/756,973

(22) Filed: Jun. 27, 2024

Related U.S. Application Data
(60) Provisional application No. 63/510,618, filed on Jun. 27, 2023.

(51) Int. Cl. G08G 5/04

(52) U.S. Cl. CPC G08G 5/045

(57) ABSTRACT

A method of managing air traffic includes acquiring information including one or more flight parameters of each aircraft with a proviso that at least one aircraft is uncrewed in a designated region surrounding a digital traffic signal; aggregating the acquired information; analyzing aggregated information with a processor; managing the digital traffic signal with at least one signal for each aircraft to avoid a collusion; and formatting and sharing a message of a unique digital traffic signal for each aircraft.

### CROSS-REFERENCE TO RELATED APPLICATIONS

This application claims the benefit of U.S. Provisional Application No. 63/510,618, filed on Jun. 27, 2023, and entitled “A METHOD AND APPARATUS FOR CREATING AND MANAGING DIGITAL TRAFFIC LIGHTS IN THE AIRSPACE”, which is incorporated herein by reference in its entirety for all purposes.

### STATEMENT REGARDING FEDERALLY SPONSORED RESEARCH OR DEVELOPMENT

None.

### BACKGROUND

In the very near future, drones, or uncrewed or unmanned aerial vehicle (UAV), or uncrewed aircraft systems (UASs) can share airspace with other crewed and uncrewed aircraft systems in and around cities. Large UASs, such as passenger-carrying vehicles, are expected to fly in skylanes established in airspace. A skylane or flight path is similar to a lane on a highway on the ground. In crewed aircraft systems, the pilot is able to sense and avoid other aircraft systems with the help from onboard instruments such as a radar, light detection and ranging (LiDAR), camera, and other electronic equipment. For a UAV, the same sense and avoid or detect and avoid (SAA or DAA) is quite challenging, because of the size, weight, and power (SWAP) and computing limitations.

Moreover, UAVs have greatly transfigured to more applicable use such as civilian applications. With this change there has been an effort to develop collision avoidance systems in order to maintain advanced air mobility (AAM). Currently UAVs are being used to transport goods to civilians. Although in the near future, UAVs expect to hold a much greater use such as transmitting people to specific destinations. Air taxis and air ambulances are rapidly becoming a reality and can provide the opportunity for civilians to commute to locations in the airspace and ambulances to respond to accidents in significantly less time

Thus, an alternative strategy for identifying other traffic to avoid current shortcomings is required for UASs to avoid potential collisions with other aircraft systems in the airspace.

### SUMMARY

In some embodiments, a method of managing air traffic comprises acquiring information including one or more flight parameters of each aircraft with a proviso that at least one aircraft is uncrewed in a designated region surrounding a digital traffic signal, aggregating the acquired information, analyzing aggregated information with a processor, managing the digital traffic signal with at least one signal for each aircraft to avoid a collusion, and formatting and sharing a message of a unique digital traffic signal for each aircraft.

In some embodiments, an apparatus for managing at least one digital traffic signal comprises an information receiver, a database architecture, a server, and a database comprising an information model, a digital traffic signal model, an aircraft model, a communication model, and a message generator for transmitting to one or more aircraft with a proviso that at least one aircraft is uncrewed.

In some embodiments, a system for managing at least one digital traffic signal comprises an information receiver for receiving information comprising aircraft priority, local weather, traffic volume, and speed, direction, and altitude of each aircraft intersecting a designated region wherein at least one aircraft intersecting the designated region is uncrewed. The system also includes a database architecture for storing received information, a server for retrieving and processing the received information, a database, comprising an information model, a digital traffic signal model, an aircraft model, and a communication model; and a message generator for transmitting a digital traffic signal to each aircraft.

In some embodiments, digital traffic lights or signals are a solution that manages traffic in the airspace similar to traffic management on the ground. This disclosure describes a method and apparatus for creating and managing one or more digital traffic signals or lights in airspace.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description:

FIG. 1 is a schematic depiction of an embodiment of a digital traffic light.

FIG. 2 is a schematic depiction of an embodiment of an operating digital traffic light.

FIG. 3 depicts a flowchart of an embodiment for airspace hazard identification and alerting.

FIG. 4 is a schematic depiction of an embodiment of an apparatus for managing air traffic with a digital traffic light.

FIG. 5 is a block diagram of an embodiment for a system.

FIG. 6 is a octagonal plot of an embodiment with corner identifiers.

FIG. 7 is a cell center points plot of an embodiment.

FIG. 8 is a pictorial depiction of a ground level view of an embodiment of an air cell intersection.

FIG. 9 is a pictorial depiction of an enlarged view of an embodiment of the air cell intersection.

FIG. 10 is a pictorial depiction of an overhead view of an embodiment of the air cell intersection.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques below, including the exemplary designs and implementations illustrated and described herein, but may be modified within the scope of the appended claims along with their full scope of equivalents.

In some embodiments, with the advancing development of AAM there is a collaborative effort to increase safety in the airspace. Generally, AAM is an advancing field of aviation contributing to the safe transportation of goods and people using aerial vehicles. When aerial vehicles are operating in high density locations such as urban locations, an incorporation of a collision avoidance system can be desirable. Standards organizations such as Institute of Electrical and Electronics Engineers (IEEE), Radio Technical Commission for Aeronautics, and General Aviation Manufacturers Association are working to develop cooperative autonomous flights using vehicle-to-vehicle (V2V) communications in structured and unstructured airspaces. This disclosure for collision avoidance strategies within structured airspaces, which can be referred to digital traffic light(s). This strategy has been demonstrated through simulation in an open platform Cesium Environment.

As AAM continues to develop there are still some overarching questions, is this safe?, how will the airspace be shared?, what does this mean for high density locations such as urban locations like cities? In order to effectively incorporate these AAM concepts there can be a system developed for the monitoring of each of these concerns. As UAVs are increasingly being used, it is expected to share the airspace with both manned and unmanned aerial vehicles. This can be done in a safe manner to ensure not only the safety of all vehicles and transported goods and people, but also for the people that are subjected to potential accidents below.

Through the use of incorporating the collision avoidance strategy digital traffic lights within structured airspaces, these concerns can be eliminated. Also considered are air corridors, air cells, digital flight rules, and UAS to UAS communications.

In some embodiments, a method establishes a digital traffic light in the airspace and managing the traffic by changing the traffic light similar to ground traffic control. The digital traffic lights can be established virtually at traffic intersections in the airspace and managed on a server located on the ground or in the cloud. This server can be part of the ground control station (GCS) infrastructure. The representation of a digital traffic light includes its airspace boundary, and color (green, red, or yellow) in each direction of traffic flow. Information about the digital traffic light can be maintained at the GCS and can be shared with all UASs that are within the vicinity of the traffic intersection through electronic messaging. This information can also be shared with the UAS operators, and other software systems and partners as required in real-time using UAS-to-UAS communications. In general terms, some embodiments involve a method and apparatus to establish a digital traffic light in airspaces and sharing its signals in the form of alerts to drones, and drone operators and other software and hardware systems.

In some embodiments, a digital representation of a traffic light can be provided. A three-dimensional (3D) volume of an air space can be described and represented by the smallest rectangular prism that encompasses this volume. In some aspects, this rectangular prism is referred to as an air cell 10 as shown in FIG. 1. Each air cell 10 is uniquely represented by its eight corners (C1 to C8). Each corner of the air cell 10 can be denoted by its latitude, longitude, and altitude. As vehicles are traveling in the intersection of air corridors, they are flying with an operational intent while being monitored by a ground control system (GCS). This GCS is using air cells to facilitate the digital flight rules concepts. These are a set of guidelines that all vehicles in and air corridors are required to follow for sustained use. Air cells monitor what cells are occupied at a specific time and prohibit the entering of other cells by vehicles. Digital traffic lights first issue new flight plans to navigate a four-way intersection. These flight plans can include a change of speed depending on the light received by the system, and then use the concept of air cells to ensure that while a vehicle is traveling there is no collision in the intersection.

While an air cell 10 is a generalized class in object-oriented programming model, a digital traffic light 20 represents a variation of, or a derived class of, an air cell 10. The digital traffic light 20 is a developed object avoidance strategy that focuses on the contribution of air corridors, air cells, digital flight rules, and UAS to UAS communications. The digital traffic light system allows for the monitoring of aerial vehicles entering as well as allocating and updating new flight plans for the safe navigation of aerial vehicles through an four-way intersection.

The purpose of a digital traffic light 20 is either to allow or not to allow traffic flows in one or more directions. A standard digital traffic light 20 can include signals in four directions, east, west, south, and north, just like a traffic light on the ground. The digital traffic light 20 may also include signals for turns as well. At any given time, the digital traffic light 20 is programmed to allow traffic only in one direction. This traffic rule can ensure potential collision avoidance at an intersection 40.

In some embodiments, a digital traffic light 20 operation is provided as follows. The digital traffic light 20 is established at the intersection 40 of two or more skylanes 30 as depicted in FIG. 2. A four-way intersection 40 is defined as an intersection of four air corridors that can cross in the airspace providing the potential risk of collision. This potential risk requires the use of a monitoring and rerouting algorithm to safely navigate all aerial vehicles through the intersection.

The skylanes 30 or air corridors 30 are virtual high ways in the sky that is a vast volume allocated for the travel of aerial vehicles. These virtual high ways are currently being used as a means to integrate airspace management for manned and unmanned aircraft flying at similar altitude.

The traffic light 20 can be color-coded (with red, yellow, and green colors) on each side including signals for possible turns. In general, a digital traffic light 20 can be programmed to manage traffic in many directions. For example, if the traffic consists of four skylanes 30, the air cell 10 at the intersection 40 can be programmed to manage the four-way traffic.

In some embodiments, a digital traffic management is provided. At any given time, only one side of the traffic light 20 can be coded green such that only one UAV can enter the traffic light 20, just like the way a traffic light operates on the ground. In FIG. 2, the digital traffic light 20 is placed at the intersection 40 of eastbound and northbound skylanes 30. It is programmed to allow only northbound vehicle. At this time, the eastbound vehicle is not be allowed to enter the intersection 40. As opposed to the traffic on the ground, UASs 50 are expected to maintain large spaces between them. In a typical scenario, multiple UASs 50 may be attempting to cross the intersection 40. However, at a given time, only one side of the air cell 10 is coded green, thus allowing only one vehicle to pass through the intersection 40.

In some embodiments, digital flight traffic rules can be implemented. The digital flight rules that are being defined for this system include a single occupancy, minimum separation distance, and overtaking does not occur in the air corridor 30. Single occupancy requires that at all times only a single vehicle can occupy a cell at any time. Minimum separation distance prohibits any vehicle from entering any air cell that is one behind an occupied cell. Lastly, there can be no overtaking in the air corridors 30. These air corridors 30 are only for the sustained use of aerial vehicles with operation intents. These rules are pivotal and are facilitated by the air cells in the GCS.

The operation and management of digital traffic lights 20 can be aligned with the implementation of digital flight traffic rules. All UASs 50 are expected to follow the digital flight rules. When navigating the four way intersection 40, every vehicle is allocated a light color (green, yellow, red) which directly changes their speed of travel. The vehicles once received their color light can also communicate their color to all surrounding vehicles using UAS to UAS communication to allow for a collaborative effort of all vehicles to navigate while maintaining object avoidance. Every aerial vehicle manned and unmanned receive their light color and surrounding vehicles light color.

The state of the digital traffic light 20 which includes the direction of allowed traffic flow can be shared with all UASs 50 within the vicinity of the intersection 40. A UAS 50 that intends to pass through the intersection 40 is verified that the digital traffic light 20 is green in the direction it is flying before entering the intersection 40.

In some embodiments, communicating the state of a digital traffic light 20 can be accomplished. The state of a digital traffic light 20 can be communicated with UASs 50 through electronic messaging. This state is represented in the form of a data structure that includes the direction of the traffic flow, along with the location of the intersection 40 in which the digital traffic light 20 is located. In addition to the state and location, the message may include other related information (meta data) such as the begin and end time of the digital traffic signal 20. All messages related to the digital traffic light 20 can be sent in real-time (with zero delay) following industry standard Json/rest format to all the UASs 50 within the vicinity of the intersection 40.

In some embodiments, a method for managing a digital traffic light 20 can be implemented. Each digital traffic light 20 can be represented in a computing system located on the ground (or in cloud) which can be referred to as a server. This server can be part of the GCS that manages the digital traffic light 20. It is possible for one server to manage multiple digital traffic lights 20. The server gathers information about all UASs 50 within the vicinity of an intersection 40 in which a digital traffic light 20 is located and decides the direction in which traffic should be allowed at any given time. The decision of the direction of traffic flow at any given intersection 40 can be based on the information that the server gathers from a variety of sources. This information includes the priority of the vehicles at the intersection 40, local weather, and the volume of traffic in each direction, among others. The server dynamically programs the digital traffic light 20 based on the information it gathers from its sources. It shares the state of the digital traffic light 20 with the GCS, the UASs 50 and their operators following the industry standards.

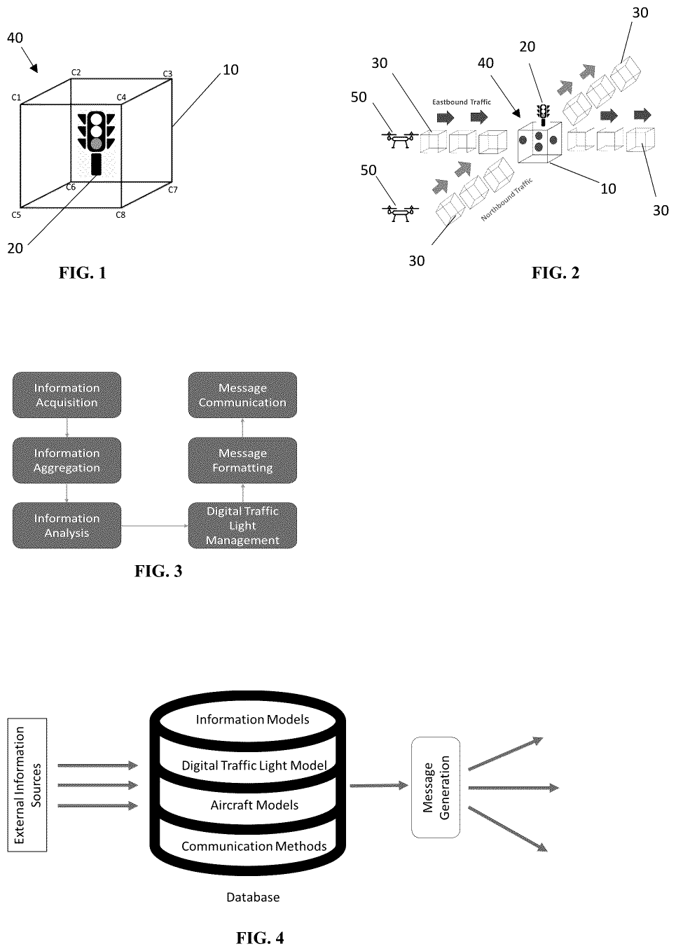

The proposed general method for managing a digital traffic light 20 at the server and sharing the state of the digital traffic light 20 with the GCS and UASs 50 involves a plurality of steps as shown in FIG. 3. Information sources vary as they depend on the region and location of the server. In some aspects, the method can comprise information acquisition, information aggregation, information analysis, digital traffic light management, message formatting, and/or message sharing.

In some embodiments, an apparatus for implementing a digital traffic light is provided. The apparatus for implementing the proposed airspace hazard identification and alerting service for drones is shown in FIG. 3. In some aspects, the system can comprise a) Database Architecture on the Ground (Distributed/Centralized/Cloud-based), b) Message Structure: Intersection Coordinates, State of Digital Traffic Light, Weather, and other related information, c) Communication Methods: Ground to Air and Air to Air, d) Information Models, e) Digital Traffic Light Model, f) Aircraft Models, or any combination thereof.

The proposed method can be implemented as a supplementary service for UASs, UAS operators, and other software and hardware systems within the ecosystem of air traffic management. Service can be offered for those who subscribe to this service.

In some embodiments, as air mobility advances, and as the skies become more populated, a traffic system can regulate to control the flow of traffic to avoid collisions. The digital traffic light system can monitor the airways and assign traffic-light colors to unmanned aerial vehicles (UAV). This system increases safety and autonomy for unmanned flights by regulating the flow of traffic. These benefits can be achieved by using vehicle-to-infrastructure (V2I) and infrastructure-to-vehicle (I2V) communication as well as digital air cells to assign vehicles entering a four-way intersection a traffic light color that corresponds to a subsequent action that taken by the vehicle to safely proceed through the four-way intersection.

In some embodiments, digital traffic lights are a system for mitigating traffic using the air corridor concept. In this system, air corridors are made up of two or more lanes allowing for structured AAM. Lanes are one-directional straight paths used to direct the flow of UAVs. This allows for a series of UAVs to flow in a single direction reducing the probability of collisions. Each lane is made up of individual air cells that help define the structure of a lane. These air cells are the fundamental building block of the air corridors system. By making use of this hierarchy, digital traffic lights generate a four-way intersection that allows for redirection and appropriate traffic flow.

In some embodiments, the digital traffic light system works with ground control stations (GCSTs) that appropriately monitor UAVs. This is done by two methods of communication, which are broadcast messages and direct messages. The broadcasted message is a form of V2I and vehicle-to-vehicle (V2V) communication that includes the heartbeat which is general information on the vehicle including telemetry data. The direct message is of V2I communication that takes place between the GCST and the UAV in the air. This direct message is a request for information (RFI) from the GCST in order to receive the vehicle's operational intent (OI). As a UAV broadcasts a heartbeat and enters the range of the GCST, the GCST begins to monitor the UAV. Once a vehicle breaks a threshold and enters the four-way intersection, a direct message is sent by the GCST to the vehicle to facilitate the traffic light infrastructure. Once the vehicle responds with its current flight plan, the GCST processes the data and checks for possible future collisions with other UAVs in the intersection. If the GCST defines more than one drone in the intersection and finds that there is potential for conflict, a system of stop-light colors such as green, yellow, and red is assigned to mitigate this collision. These colors effectively slow the speed of the drones in a queue system that allows for safe traversal in the intersection.

In some embodiments, the rules of engagement can be defined for single occupancy, minimum separation distance, and overtaking. As an example, an air cell is a defined volume in space, each cell is limited in the volume restricting the occupation of a cell. This specification requires the single occupancy digital flight rule. Single occupancy can allow only a single vehicle in an air cell at a time providing a perfect implementation for vehicles to operate. If a vehicle is attempting to enter an already occupied air cell, the system can restrict the continuation of the flight directly by reducing the speed of the vehicle to ensure that there is no two or more vehicles in a single cell. This measure can ensure the safety of all vehicles in the air space.

Regarding minimum separation distance, as a flight operation takes place, vehicles usually maintain a minimum separation distance to avoid collisions. This minimum separation distance is defined as at least one unoccupied air cell between two flights at all times. Air cells monitor the in route flight operations by checking what air cells are actively occupied as well determining the next air cell to be occupied. If there is an air cell that is occupied and the next air cell for that flight is already occupied, the system restricts the continuation of that flight due to the potential collision. In response, the speed of the vehicle can be affected by allocating the preceding vehicle sufficient amount of time to clear the next air cell. Once the minimum separation distance has been restored, the speed of the vehicle can be returned to its previous speed. The administration of this digital flight rule ensures the safety of all in route vehicles.

Regarding overtaking, as there is no standardized speed for micro air vehicles (MAVs) and UAVs within air corridors, the potential of entering an occupied air cell and breaking the minimum separation distance is very high. Although, if the speed of one vehicle is much greater than a preceding vehicle, why not over take it? Overtaking another vehicle is the act of passing a vehicle which can be done for a multitude of reasons including faster delivery, less potential of collision, etc. Although, within air corridors there can be no overtaking, air corridors can be a large stretch of volume allocated for the transportation of aerial vehicles. Generally, these volumes do not provide enough space for safe side-by-side travel as well as a cell cannot contain more than one occupancy due to high risk. In order to facilitate this process, the digital flight rule of a break down lane can be implemented.

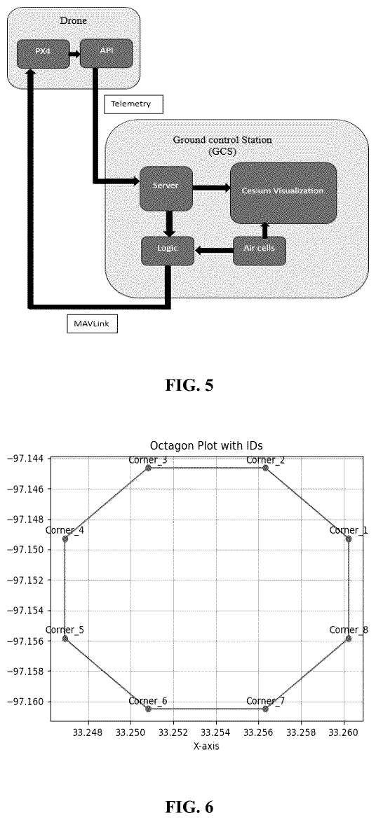

In some embodiments, a system model may be utilized. As an example, for the development of the Digital Traffic Lights system, the Software-In-The-Loop (SITL) autopilot software PX4-Autopilot can be used to simulate the flights of UAVs. A simple application programming interface (API) using the micro air vehicle link (MAVLink) protocol is used to extract the telemetry data of the software-defined UAVs, which is then transmitted to a test environment developed by the University of North Texas by making use of the open platform CesiumJS environment. This environment allows for all UAVs to be visualized as the flight rules logic constantly changes the flight of the UAVs by sending the appropriate MAVLink commands. The digital stop light system uses the air cell system to generate the rules of engagement, which is also simulated in the CesiumJS environment. Since the air cells are integral to the digital stop light system, the occupancy of the cell that the drone occupies can be tracked at all times, reducing collisions of UAVs and allowing for safe navigation. The simple block diagram of the system can be seen in FIG. 5. In some embodiments, the intersection for the digital traffic light system makes use of two corridors with two lanes in each corridor. The two corridors are perpendicular to one another, consisting of two lanes parallel to one another that support the flow of traffic in opposite directions. This is to say that there is a corridor that stretches with one lane going north to south and another going south to north. The second corridor stretches similarly, with one going east to west and another west to east. This allows for all directions of traffic to exist which ultimately requires the digital traffic light system to control the traffic flow. In each lane, a system of cells is interlinked to establish lane structures in the airway. To establish these lanes, the air cells are developed using the dimensional properties of an octagon.

The concept of an octagon allows for lanes to be developed by making use of the points on the polygon directly opposite of one another and connecting them which effectively creates four lanes. Each lane represents a flow of traffic in all four cardinal directions. These lanes are then divided into cells to create the entire ecosystem of the system that allows for the GCS to monitor the flight of all drones in the intersection.

The digital stop light architecture uses a circumscribed circle to define the vertices on the octagon by using the circumradius. This simple algorithm uses the center position of the interchange and the circumradius of the system to calculate points in space that represent the vertices of the octagon at every 45 degrees on a circumcircle. The latitude and longitude position for each vertices in the octagon shape can be calculated with the equations below.

$${lat}_{n} = h + R \cdot cos ( \frac{n \cdot 360 °}{8} + α ) \qquad ( 1 )$$

$${lon}_{n} = k + R \cdot sin ( \frac{n \cdot 360 °}{8} + α ) \qquad ( 2 )$$

In the equations above h and k are the latitude and longitude values respectively of the specified center position where the digital stop light infrastructure is to be generated. In this example, h is equal to 33.25356928863392, and k is equal to −97.1525712200369. This allows for this system to be developed on spot at any location required. The size of the interchange can be dynamically fitted to any size desired by changing the circumradius R. The algorithm then uses the variable n as the index of the current angle for the vertice that is to be generated. The initial deceleration of the octagon is oriented towards the north-west cardinal direction with a heading of 315 degrees. In order for the interchange to be generated with true cardinal directions, the octagon faces true north. Therefore, the generated octagon has an offset variable a of 45 degrees. After iterating through each vertex of the octagon and calculating its positions, the plotted positions for each vertice can be seen in FIG. 6.

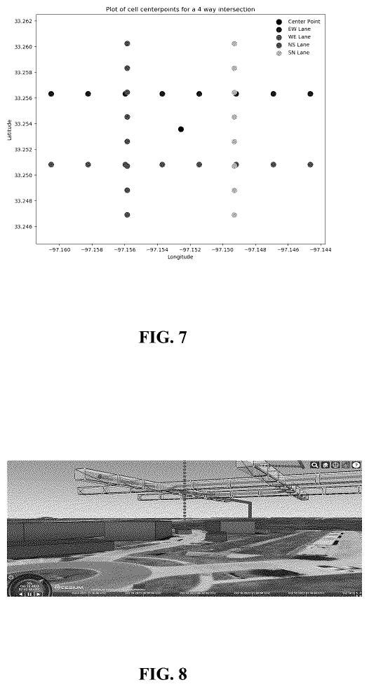

With the implementation of the algorithm, the octagon structure defines eight vertices used for creating lanes. These lanes are generated by connecting opposite vertices in the polygon to define lines. This creates four different lanes to be used for each direction of traffic. Upon the generation of the lanes, equidistant points are plotted along the lanes which represent the center positions of the air cell. The plotted center points of the cells are depicted in FIG. 7.

After all the center points of the air cells in the intersection are defined, the flight path of each route is defined. A Dijkstra algorithm is used to define the most optimal path through the intersection. This algorithm generally allows for all the paths through the intersection such as straight, right, left, and U-turn to be defined using the center points of the air cells. The Dijkstra algorithm allows for the routes through the interchange to be generated based on the ingress point and egress point. This allows for all possible paths in the intersection to be defined.

In some embodiments, a routing algorithm can be utilized. As an example, when a vehicle enters the intersection, the vehicle efficiently traverses through while conforming to the flow and direction of traffic. To achieve this, an algorithm is developed that utilizes the Dikjras algorithm to generate a route through the intersection for the UAV. The algorithm evaluates the UAVs ingress and egress direction to determine the lanes that the drone travels through. The air cell interchange only allows for the direction of traffic to flow in one direction, and so only the lanes allowing the UAV to conform to standard road rules are considered, while the other lanes are ignored. For example, if the ingress is north and egress is east, only the north-south and west-east lanes are used for the UAV to traverse through. To generate the route, the center points of all the air cells in each lane are inserted into a graph. The source node in this case is the first air cell in the ingress lane and the target node is the last air cell in the egress lane. Once the graph is created and the source and target nodes are declared, edges are created between the nodes with the weights being equal to the distance. Once the edges are created, Dikjras algorithm is then used to generate the shortest path from the source node to the target which then generates the path the UAV traverses through the intersection.

When a UAV or many UAVs enters the intersection radius defined as 800 meters from the center point, the newly generated flight plans from the Dijkstra algorithm are queued. The distance is determined by measuring the real position of the UAV asynchronously to the center point of the intersection as seen in Equations 3 through 7 below:

$$dlat ( radians ) = centralat - UAV lat \qquad ( 3 )$$

$$dlon ( radians ) = centerlon - UAVlon \qquad ( 4 )$$

$$a = {sin ( \frac{dlat}{2} )}^{2} + cos ( UAVlat ) cos ( centerlat ) {sin ( \frac{dlon}{2} )}^{2} \qquad ( 5 )$$

$$c = 2 * atan 2 ( sqrt ( a ) , sqrt ( 1 - a ) ) \qquad ( 6 )$$

$$distance ( meters ) = c * 6371000.0 \qquad ( 7 )$$

The queued UAVs are given light colors green, yellow, or red which directly vary their speeds to ensure no collisions. This allocation of light colors is done using an intersection check. The way points are used to create a line for each UAV. With the number of intersections defined for each UAV, the colors are then assigned. The UAV with the least amount of intersections is given the green light due to the least chance of collision. Similarly, the light colors are distributed (with respect to green, yellow, and red) in increasing order of number of intersections. If the UAV leaves the radius of the intersection, the UAV is removed from the queue allowing for the remaining UAVs in the intersection and any new UAV that enters the radius to get a new light distribution.

In order to queue a UAV and make use of the Dijkstra algorithm, the 800 meter radius is used from the center point of the interchange. The equations for determining if the UAV is in the radius make use of the Haversine formula. In Equations 3 and 4 above, the difference of the latitude and longitude between the UAVs position and the center of the interchange is determined. These are known as the dlat and dlon values and they are used in the calculation for the square of half the chord length known as “a” as seen in Equation 5. After “a” is defined, the angular distance in radians on the sphere is calculated known as a constant “c”, as depicted in Equation 6 above. Finally the distance is calculated in Equation 7 by multiplying the angular distance “c” with the radius of the earth.

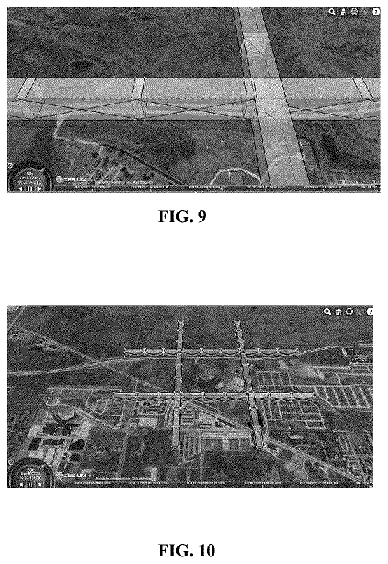

As an example, a simulation can be conducted. After the system has been developed, the simulation of the system demonstrates viability. As discussed above, the simulation environment may be built in the CesiumJS environment allowing for a three-dimensional intersection to be developed using air cells in a geo-referenced environment. This environment allows for a visualization of UAVs in the environment, as depicted in FIGS. 8-10. As depicted, these images show a fully constructed air cell intersection with two UASs traversing safely through. The red and green trails are those of the drones flying simultaneously through the air cell interchange without a collision.

Thus, a novel method and system for increasing safety and autonomy in the airways, which is a digital traffic light system that uses air cells to structure and manage traffic. The ground control station system monitors drones in the interchange and assigns routes and light colors based on multiple factors. The interchange air cell system can also be introduced to structure the airspace. The solution can be implemented and used in live flights and to facilitate a collision-free flight for UAVs.

Having described various systems and methods herein, certain embodiments can include, but are not limited to:

In a first aspect, a method of managing air traffic, comprises acquiring information including one or more flight parameters of each aircraft with the proviso that at least one aircraft is uncrewed in a designated region surrounding a digital traffic signal; aggregating the acquired information; analyzing the aggregated information with a processor; managing the digital traffic signal with at least one signal for each aircraft to avoid a collusion; and formatting and sharing a message of a unique digital traffic signal for each aircraft.

A second aspect can include the method of the first aspect, wherein each aircraft is, independently, a manned aircraft or an uncrewed aircraft, and the method continuously and dynamically updates acquiring, aggregating, analyzing, managing, formatting, and sharing.

A third aspect can include the method of the first aspect or the second aspect, wherein the designated region comprises an air cell defined by latitude, longitude, and altitude coordinates.

A fourth aspect can include the method of any one of the proceeding aspects, wherein the digital traffic signal comprises one of three signals including, independently, proceed on path, proceed with caution, or turn from current skylane.

A fifth aspect can include the method of the fourth aspect, wherein the proceed on path digital traffic signal corresponds to an imaged green color for a display, the proceed with caution digital traffic signal corresponds to an imaged yellow color for a display, and the turn from current skylane digital traffic signal corresponds to an imaged green color for a display, and an appropriate digital traffic signal is communicated to each aircraft pilot or operator as an imaged color on a display.

A sixth aspect can include the method of any one of the proceeding aspects, wherein the acquired information comprises aircraft priority, local weather, traffic volume, and speed, direction, and altitude of each aircraft intersecting the designated region.

A seventh aspect can include the method of any one of the proceeding aspects, wherein an aircraft receiving a turn from current skylane digital traffic signal alters its current skylane by changing direction or altitude.

An eighth aspect can include the method of any one of the proceeding aspects, wherein an aircraft receiving a turn from current skylane digital traffic signal alters its current speed by increasing or decreasing its speed.

A ninth aspect can include the method of any one of the proceeding aspects, further comprising a plurality of digital traffic signals, and the plurality of digital traffic signals are represented in a computing system located on the ground or in a cloud.

A tenth aspect can include the method of any one of the proceeding aspects, wherein the computing system manages the digital traffic signal based on the acquired information and shares one or more messages including a state of the digital traffic signal with a ground control station, each aircraft, and the operator or pilot of each aircraft.

An eleventh aspect can include the method of any one of the proceeding aspects, wherein each aircraft is an uncrewed aircraft.

A twelfth aspect can include the method of any one of the proceeding aspects, wherein the signal for turning from current skylane provides specific coordinates, altitude, and speed for a new skylane.

In another thirteenth aspect, an apparatus for managing at least one digital traffic signal, comprises an information receiver; a database architecture; a server; a database, comprising an information model, a digital traffic signal model, an aircraft model, and a communication model; and a message generator for transmitting to one or more aircraft with the proviso that at least one aircraft is uncrewed.

A fourteenth aspect can include the apparatus of the thirteenth aspect, wherein the message generator transmits a digital traffic signal to each aircraft intersecting a designated region.

A fifteenth aspect can include the apparatus of the thirteenth aspect or the fourteenth aspect, wherein the message generator is configured to provide intersection coordinates, digital traffic signal status, and local weather.

A sixteenth aspect can include the apparatus of any one of the thirteenth aspect to the fifteenth aspect, wherein the information receiver and generator are configured to communicate either ground-to-air or air-to-air.

A seventeenth aspect can include the apparatus of any one of the thirteenth aspect to the sixteenth aspect, wherein the information receiver is configured to receive information comprising aircraft priority, local weather, traffic volume, and speed, direction, and altitude of each aircraft intersecting the designated region.

In a further eighteenth aspect, a system for managing at least one digital traffic signal, comprises an information receiver for receiving information comprising aircraft priority, local weather, traffic volume, and speed, direction, and altitude of each aircraft intersecting a designated region wherein at least one aircraft intersecting the designated region is uncrewed; a database architecture for storing received information; a server for retrieving and processing the received information; a database, comprising an information model, a digital traffic signal model, an aircraft model, and a communication model; and a message generator for transmitting a digital traffic signal to each aircraft.

A nineteenth aspect can include the system of the eighteenth aspect, wherein system continuously and dynamically updates with current traffic information for transmitting digital traffic signals.

A twentieth aspect can include the system of the eighteenth aspect or the nineteenth aspect, wherein a transmitted digital traffic signal is converted to a visual image for each aircraft pilot or uncrewed vehicle.

It is to be further understood that the present description is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present systems and methods. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this description belongs. Preferred methods, techniques, devices, and materials are described, although any methods, techniques, devices, or materials similar or equivalent to those described herein may be used in the practice or testing of the present systems and methods. Structures described herein are to be understood also to refer to functional equivalents of such structures. The present systems and methods have been described in detail above with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

It should be understood that the scope of the disclosure also includes any novel feature or any novel combination of features disclosed herein either explicitly or implicitly or any generalization thereof, whether or not it relates to the same systems or methods as presently claimed in any Claim and whether or not it mitigates any or all of the same technical problems as do the present systems and methods.

Features which are described in the context of separate embodiments may also be provided in combination in a single embodiment. Conversely, various features which are, for brevity, described in the context of a single embodiment, may also be provided separately or in any suitable sub-combination. The Applicants hereby give notice that new claims may be formulated to such features and/or combinations of such features during the prosecution of the present Application or of any further Application derived therefrom.

For purposes of the disclosure herein, the term “comprising” includes “consisting” or “consisting essentially of.” Further, for purposes of the disclosure herein, the term “including” includes “comprising,” “consisting,” or “consisting essentially of.”

Accordingly, the scope of protection is not limited by the description set out above but is only limited by the claims which follow, that scope including all equivalents of the subject matter of the claims. Each and every claim is incorporated into the specification as an aspect of the present disclosure. Thus, the claims are a further description and are an addition to the aspects of the present invention. The discussion of a reference herein is not an admission that it is prior art to the presently disclosed subject matter, especially any reference that may have a publication date after the priority date of this application. The disclosures of all patents, patent applications, and publications cited herein are hereby incorporated by reference, to the extent that they provide exemplary, procedural or other details supplementary to those set forth herein.

While embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R_{L}, and an upper limit, R_{U}, is disclosed, any number falling within the range is specifically disclosed. In particular, the following numbers within the range are specifically disclosed: R=R_{L}+k*(R_{U}−R_{L}), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

1. A method of managing air traffic, comprising:
acquiring information including one or more flight parameters of each aircraft with a proviso that at least one aircraft is uncrewed in a designated region surrounding a digital traffic signal;
aggregating the acquired information;
analyzing aggregated information with a processor;
managing the digital traffic signal with at least one signal for each aircraft to avoid a collusion; and
formatting and sharing a message of a unique digital traffic signal for each aircraft.

2. The method of claim 1, wherein each aircraft is, independently, a manned aircraft or an uncrewed aircraft, and the method continuously and dynamically updates acquiring, aggregating, analyzing, managing, formatting, and sharing.

3. The method of claim 1, wherein the designated region comprises an air cell defined by latitude, longitude, and altitude coordinates.

4. The method of any one of claim 1, wherein the digital traffic signal comprises one of three signals including, independently, proceed on path, proceed with caution, or turn from current skylane.

5. The method of claim 4, wherein the proceed on path digital traffic signal corresponds to an imaged green color for a display, the proceed with caution digital traffic signal corresponds to an imaged yellow color for a display, and the turn from current skylane digital traffic signal corresponds to an imaged green color for the display, and an appropriate digital traffic signal is communicated to each aircraft pilot or operator as an imaged color on the display.

6. The method of any one of claim 1, wherein the acquired information comprises aircraft priority, local weather, traffic volume, and speed, direction, and altitude of each aircraft intersecting the designated region.

7. The method of any one of claim 1, wherein an aircraft receiving a turn from current skylane digital traffic signal alters its current skylane by changing direction or altitude.

8. The method of any one of claim 1, wherein an aircraft receiving a turn from current skylane digital traffic signal alters its current speed by increasing or decreasing its speed.

9. The method of any one of claim 1, further comprising a plurality of digital traffic signals, and the plurality of digital traffic signals are represented in a computing system located on a ground or in a cloud.

10. The method of any one of claim 1, wherein a computing system manages the digital traffic signal based on the acquired information and shares one or more messages including a state of the digital traffic signal with a ground control station, each aircraft, and an operator or a pilot of each aircraft.

11. The method of any one of claim 1, wherein each aircraft is an uncrewed aircraft.

12. The method of any one of claim 1, wherein the signal for turning from current skylane provides specific coordinates, altitude, and speed for a new skylane.

13. An apparatus for managing at least one digital traffic signal, comprising:
an information receiver;
a database architecture;
a server;
a database, comprising an information model, a digital traffic signal model, an aircraft model, and a communication model; and
a message generator for transmitting to one or more aircraft with a proviso that at least one aircraft is uncrewed.

14. The apparatus of claim 13, wherein the message generator transmits a digital traffic signal to each aircraft intersecting a designated region.

15. The apparatus of claim 13, wherein the message generator is configured to provide intersection coordinates, digital traffic signal status, and local weather.

16. The apparatus of any one of claim 13, wherein the information receiver and generator are configured to communicate either ground-to-air or air-to-air.

17. The apparatus of any one of claim 13, wherein the information receiver is configured to receive information comprising aircraft priority, local weather, traffic volume, and speed, direction, and altitude of each aircraft intersecting a designated region.

18. A system for managing at least one digital traffic signal, comprising:
an information receiver for receiving information comprising aircraft priority, local weather, traffic volume, and speed, direction, and altitude of each aircraft intersecting a designated region wherein at least one aircraft intersecting the designated region is uncrewed;
a database architecture for storing received information;
a server for retrieving and processing the received information;
a database, comprising an information model, a digital traffic signal model, an aircraft model,
and a communication model; and
a message generator for transmitting a digital traffic signal to each aircraft.

19. The system of claim 18, wherein the system continuously and dynamically updates with current traffic information for transmitting digital traffic signals.

20. The system of claim 18, wherein a transmitted digital traffic signal is converted to a visual image for each aircraft pilot or uncrewed vehicle.
